(19) United States
(12) Patent Application Publication
(10) Pub. No.: US 2015/0162947 A1
(43) Pub. Date: Jun. 11, 2015

(54) DATA COMMUNICATION DEVICE FOR A TRANSPORT MEANS

(71) Applicant: Lufthansa Systems AG, Kelsterbach (DE)

(72) Inventors: Peter Hommel, Bad Homburg (DE); Jörg Liebe, Wiesbaden (DE)

(21) Appl. No.: 14/391,149

(22) PCT Filed: Apr. 10, 2013
(86) PCT No.: PCT/EP2013/057489

§ 371 Date: Feb. 5, 2015

(30) Foreign Application Priority Data
Apr. 11, 2012 (DE) 10 2012 205 884.2

(51) Int. Cl. H04B 1/3888; H04B 1/3883; H04W 4/02

(52) U.S. Cl. CPC H04B 1/3888; H04W 4/02; H04B 1/3883; H04W 84/12

(57) ABSTRACT

A simplified mobile data communication device (10) for a transport means has a data server (14) and a broadband data communication interface (16) connected to the data server (14), the data communication device (10) having an entirely sealable, portable housing (12) which entirely surrounds the data server (14) and the data communication interface (16).

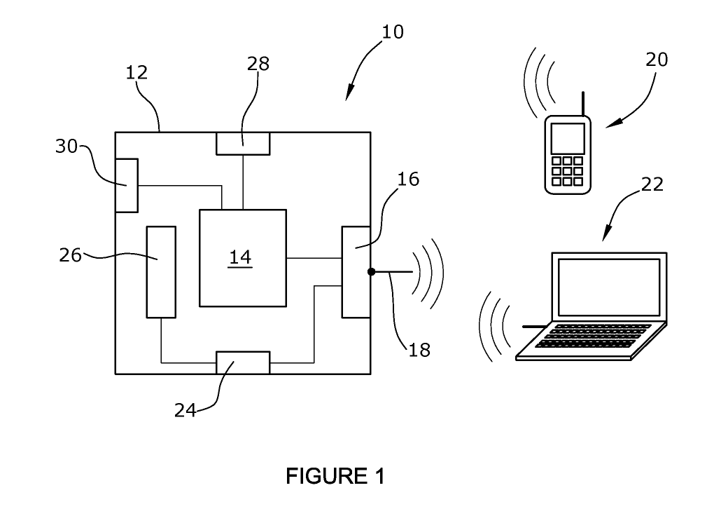

The invention relates to a data communication device for a transport means.

In means of transport, such as aircraft, busses, trains or ships, for example, data communication devices are often installed that enable passengers to watch video films, listen to music or to surf the Internet during travel. The installation of such a data communication device in a respective means of transport is complicated. Conventionally, video monitors, speakers, headphone connectors and/or operating panels are installed in the passenger seats or in the passenger cabin, which devices are each connected by wires to a data server. With more recent data communication devices in means of transport, the data server which holds the data to be called up by the passengers, is connected with radio interfaces, e.g. according to the WLAN standard, so that passengers can establish a link to the data server via their own user terminal device, such as a cell phone or a portable computer (tablet PC). In any case, the data server and the radio interfaces, as well as the necessary wiring are permanently installed in the means of transport. Damages or malfunctions can affect the means of transport as safety risks, e.g. in the form of cable fires. Therefore, conventional data communication devices have to pass a complex safety-related approval procedure, in particular when they are used in aircraft.

It is an object of the invention to provide a simplified data communication device for a means of transport.

The data communication device of the invention is defined by the features of claim 1.

The mobile data communication device for a means of transport comprises a data server, a broadband data communication interface connected to the data server, and a housing. The housing can be closed completely, it is portable and encloses the data server and the broadband data communication interface. The data server stores data that can be called up by users via the broadband data communication interface. For instance, these data can be audio data, such as music, for example, video data, such as video films, for example, and/or electronic trading data for making purchases in the means of transport (“e-commerce”). Using a terminal device, such as a cell phone or a portable computer, for example, a user can establish a data link to the data communication interface and retrieve the electronic data from the server. In this regard, the broadband data communication interface allows the simultaneous establishment of a plurality of data links, so that a plurality of passengers in the means of transport can access the data server. It is intended that, preferably, a plurality of users, e.g. at least 30 and in particular at least 50 users, can establish a link to the data server.

The data communication device can be installed in a simple manner at a suitable position in the means of transport without having to make any cable connections or mechanical connections. The data communication device is entirely self-contained and merely requires a small positioning surface or a holder to receive the same. The housing can be provided with a voltage supply interface to make a connection to a voltage supply network, e.g. the on-board network o the means of transport. The voltage supply interface powers the data server and the data communication interface if a suitable cable is connected thereto. As an alternative or in addition, the data communication device can comprise batteries, specifically rechargeable accumulators, in the housing for voltage supply to the data server and/or the data communication interface. The accumulator can be recharged via the voltage supply interface.

It is conceivable that the housing has a radio interface for establishing an Internet link. The radio interface can be designed as a narrowband interface or according to one of the GSM, GPRS, LTE, WiMax or WLAN standards. The radio interface is connected at least to the data server or to the data communication interface so that users can also access the Internet via the broadband data communication interface. Thereby, an internet connection can be made available once the means of transport is near a corresponding transmitter.

It is further conceivable to equip the data communication device with a GPS sensor that automatically detects the respective position of the data communication interface. Users shall be able to call the position information via the data communication interface.

Preferably, the data server contains a software that automatically indicates the current position of the data communication device to the users in dependence of the position detected by the GPS sensor. The software can be accessed via the data communication interface.

The housing can comprise a microphone which picks up ambient noises and enables an interruption of data playback or data communication via the broadband communication interface when a predefined acoustic signal is received. By the acoustic transmission of a defined signal, e.g. a two-channel sound, inside the cabin, data playback or data transmission can be interrupted in order to issue announcements to the passengers. For this purpose, software is installed on the data server that performs a permanent sound analysis of the noises picked up by the microphone and, upon detection of the predefined signal, interrupts data transmission or data playback. When a further, predefined signal is received that indicates the end of an announcement, data transmission or data playback can be continued.

Advantageously, the housing is made of a heat-resistant, watertight and/or shock-absorbing material.

The use of the mobile data communication device in a means of transport, such as in a coach, an aircraft, a train or a ship, for example, allows for a simplified provision of entertainment programs to be called up electronically by passengers.

The following is a detailed description of an embodiment of the invention with reference to the FIGURE. The FIGURE is a schematical illustration of the data communication device of the present invention.

The mobile data communication device 10 comprises a housing 12, a data server 14 and a broadband data communication interface 16 connected to the data server 14.

The housing 12 is made of a heat-resistant, watertight and shock-absorbing material. In order to enable access to the interior of the housing 12, the same is provided with a closable opening not illustrated in the FIGURE. The housing 12 contains the data server 14 and the data communication interface 16. Only a WLAN radio antenna 18 is mounted on the outer side of the housing 12 so that the housing 12 does not interfere with the radio reception. Using the data communication interface, user terminal devices, such as cell phones 20 with WLAN capability or portable computers 22 with WLAN capability, can build a radio link and, via this radio link, access the data stored on the data server 14. The data server 14 may store video films or music which are transmitted to the user terminal devices 20, 22 as a data stream, wherein it is prevented to store the data on the terminal devices 20, 22 or to modify the data on the data server 14. Further, a program can be stored on the data server 14 that enables electronic trading (“e-commerce”) for purchasing products on board the means of transport.

The data communication device 10 comprises a voltage supply interface 24 connected to the data server and the data communication interface 16 to supply voltage to the same. The voltage supply interface 24 can be connected to the onboard voltage network of the means of transport. Further, the housing 12 accommodates an accumulator 26 that is connected to the voltage supply interface 24, the data server 14 and the data communication interface 16. The accumulator 26 can be charged via the voltage supply interface 24. The accumulator supplies electrical power to the data server 14 and the data communication interface 16.

The data communication device 10 further comprises a GPS sensor 28 connected to the data server 14. The data server 14 stores a so-called “moving map” software which, in dependence on the position detected by the GPS sensor 28, transfers the current position of the data communication device 10 to a map in real time, which map is transmitted from the data server 14 to one of the terminal devices 20, 22 where it is displayed. Thereby, each user can track the current position, the speed, the traveling direction and other travel data in real time via his terminal device 20, 22.

Moreover, a microphone 30 exposed to the outer side is arranged in the housing 12, which receives ambient noise from outside the housing 12. The microphone 30 is connected to the data server 14 which is provided with an audio recognition software to analyze the ambient noise. During the operation of the data communication device, the audio recognition software runs continuously in the background, at least while data are transmitted via the data communication interface 16. When a certain predefined acoustic signal, e.g. a defined two-channel sound, is received, the audio recognition software causes an interruption of the data transmission. When another predefined signal is received, the audio recognition software causes the continuation of the data transmission. If the crew of the means of transport has to make important announcements to the passengers, an automatic interruption of the data transmission can be made, so that the users of the terminal devices 20, 22 are enabled to hear the announcement.

1. A mobile data communication device for a means of transport, comprising a data server and a broadband data communication interface connected to the data server, the data communication device having an entirely sealable, portable housing which entirely surrounds the data server and the data communication interface.

2. The mobile data communication device of claim 1, wherein the data server contains audio data, video data and/or electronic trading data, each stored in electronic form, for transmission via the data communication interface.

3. The mobile data communication device of claim 1, wherein the data communication interface is configured as a broadband WLAN interface for simultaneous communication with at least 30 and preferably at least 50 WLAN terminal devices.

4. The mobile data communication device of claim 1, wherein the housing comprises at least one voltage supply interface and/or at least one rechargeable battery for supplying the data server and the data communication interface.

5. The mobile data communication device of claim 1, wherein the data communication device comprises a radio interface connected to the data communication interface and configured for establishing a link to the Internet.

6. The mobile data communication device of claim 1, wherein the data communication device comprises a GPS sensor connected to the data server and/or the data communication interface.

7. The mobile data communication device of claim 6, wherein the data server contains a software for the visualization of the position of the data communication device detected by the GPS sensor, the position being visualized on the terminal devices of the users.

8. The mobile data communication device of claim 1, wherein the housing comprises a microphone connected to the data server for interrupting data transmission to the users upon reception of a predefined acoustic signal.

9. The mobile data communication device of claim 1, wherein the housing is made of a heat-resistant, watertight and/or shock-absorbing material.

10. Use of a mobile data communication device of claim 1 as a mobile device in a means of transport.
